(19) United States
(12) Patent Application Publication
(10) Pub. No.: US 2011/0087962 A1
(43) Pub. Date: Apr. 14, 2011

(54) METHOD AND APPARATUS FOR THE AUTOMATIC PREDICTIVE SELECTION OF INPUT METHODS FOR WEB BROWSERS

(75) Inventor: Michael Paddon, Tokyo (JP)

(73) Assignee: QUALCOMM Incorporated, San Diego, CA (US)

(21) Appl. No.: 12/579,225

(22) Filed: Oct. 14, 2009

(51) Int. Cl. G06F 17/27

(52) U.S. Cl. 715/265

(57) ABSTRACT

A method and apparatus for predictively selecting an input method at a web browser. Once a user has entered information identifying a web page, contextual information at the web page is examined in order to automatically, predictively select an appropriate input method for the web page. Once the input method has been selected, a corresponding predictive typing program may be applied.

### BACKGROUND

An input method is a mechanism which allows users to enter characters, symbols, or words which are not directly represented on their other input device, such as a keyboard. Input methods are often used to enter non-Latin glyphs, such as Chinese, Japanese, Korean, or Indic scripts, from a standard QWERTY keyboard. Input methods are also used to enter Latin alphabet characters on smaller input devices, such as a mobile phone keypad. As smaller input devices or keyboards are used for mobile telephones and digital assistants, input methods are used for Latin based languages as well. Input methods are enabled through an operating system component or program.

When operating in a multi-lingual environment, a web browser should support multiple input methods. This allows the input of glyphs from different writing scripts. This may be difficult as a single script (e.g. the Latin alphabet) may be used in the context of more than one language.

It is currently common practice for a browser to default to either the user's native input method or perhaps the most recently used input method. The user may then select an alternate input method manually. Selecting a new input method may require selecting a script, a language, and/or a locality, in any combination.

While manual selection suffices for users using web applications in one script or language, it becomes cumbersome for truly multi-lingual users and applications. This is especially true of mobile devices, whose small keyboards tend to mandate the need for multiple keystrokes to change the input method. These additional keystrokes substantially impact usability.

Predictive typing selection has become widely popular, especially in the cell phone industry, as an accelerator for textual input. By examining the first few keystrokes or glyphs of input, possibly along with context comprising recently input words and memory of previous choices, predictive typing selection may present the user with a list of possible completions to choose from. In order to apply a suitable predictive text algorithm, however, the script and language of the input must be known. In addition to the drawbacks noted above, the additional input required to manually select changes in input methods erodes the benefits of predictive typing acceleration.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects include enhancing the usability of web browser input methods for multi-lingual applications by automatically, predictively selecting the correct input method without requiring additional selection by a user.

Aspects include a method for predictively selecting an input method at a web browser, the method including analyzing at least one contextual factor for a web page; automatically predictively selecting one of a plurality of input methods based on the analysis of the at least one contextual factor for the web page; receiving user input; and displaying the user input according to the selected input method.

The analysis of the at least one factor may include examining a text encoding method used for the web page, examining words on the web page in order to determine a language from the words, examining meta-information embedded in the web page, examining the Uniform Resource Locator (URL) or Universal Resource Identifier (URI) of the web page. The web page may include universal character encoding, and the analysis of the at least one factor may include examining a numerical distribution of the code points for the web page in order to determine a range in which the code points cluster.

If the analysis includes examining words on a web page in order to determine a language for the words, the analysis may include determining a frequency distribution of languages represented on the web page and applying a weight to the represented languages.

An examination of meta-information embedded in the web page may further include determining whether the meta-information includes a language tag. A URI or URL may include an internationalized domain name, and the analysis may further include examining the distribution of code points in the URI or URL to determine a range in which the code points cluster. The various analyses may be used in any combination with each other, and a weight may be given to the results of the analysis of different factors.

Aspects may further include applying predictive typing based on the selected input method.

Other aspects include a computer program product, including: a computer-readable medium having: code for causing a computer to receive a first input for a web page; code for causing the computer to analyze at least one contextual factor for the web page; code for causing the computer to automatically predictively select one of a plurality of input methods based on the analysis of the at least one contextual factor for the web page; code for causing the computer to receive a second user input; and code for causing the computer to display the second user input according to the selected input method.

Other aspects include an apparatus, including: means for examining at least one contextual factor for a web page; means for automatically predictively selecting one of a plurality of input methods based on the analysis of the at least one contextual factor for the web page; means for receiving a user input; and means for communicating the user input for display according to the selected input method.

Other aspects include an apparatus, including: an examination component for analyzing at least one contextual factor for the web page; an input method selection component for automatically predictively selecting one of a plurality of input methods based on the analysis of the at least one contextual factor for the web page; a display; and a user interface for receiving user input and presenting the user input to the display according to the selected input method.

The examination component may be configured to examine a text encoding method used for the web page. The web page may include universal character encoding, and the examination component may be configured to examine a numerical distribution of the code points for the web page in order to determine a range in which the code points cluster.

The examination component is configured to examine words on the web page in order to determine a language from the words. The examination component may further be configured to determine a frequency distribution of languages represented on the web page. The input method selection component may be configured to apply a weight to the represented languages. The examination component may be configured to examine meta-information embedded in the web page and to determine whether the meta-information includes a language tag. The examination component may be configured to examine the URI or URL of the web page. When the URI or URL includes an internationalized domain name, the examination component may be further configured to examine the distribution of code points in the URI or URL to determine a range in which the code points cluster.

The apparatus may include a predictive typing method selection component configured to apply a predictive typing algorithm based on the selected input method.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is an illustration of an exemplary method for predictively selecting an input method.

FIG. 2 is an illustration of another exemplary method for predictively selecting an input method.

FIG. 3 is an illustration of a computer device for predictively selecting an input method.

FIG. 4 is an illustration of a computer device for predictively selecting an input method.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As noted above, a manual selection is required in order for a user to change between input methods. Each web page visited by a user includes a large amount of contextual information that could instead be used by a browser to make an automatic predictive selection of input method. This would remove the cumbersome need for a multilingual user to make manual changes to the input method as the user interacts with different web pages.

Thus, aspects include using contextual information from a web page to make an automatic predictive selection of an input method. The selected input method is then applied to any input, such as typing, received from the user. Once the input method has been selected, an appropriate algorithm for predictive typing may also be applied.

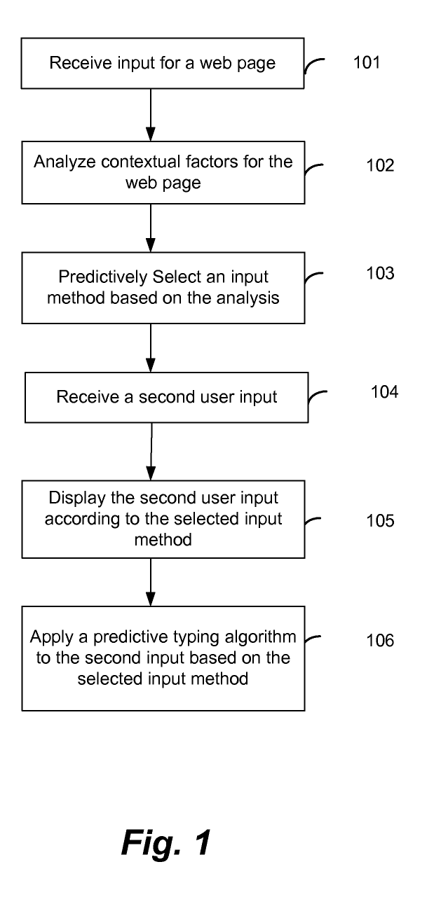

FIG. 1 illustrates an exemplary method of automatically, predictively selecting an input method. At 101, a first input for a web page is received from a user. The web page contains multiple contextual factors that can be analyzed in order to predictively select the input method that will be most appropriate for the web page. At 102, at least one contextual factor is analyzed for the web page. Exemplary factors are described in more detail below. An input method is automatically, predictively selected at 103 based on the analysis in 102.

Multiple input methods may correspond to a single language. Input methods for a common language may vary based on, among other things, any combination of script, language, and/or locality. The automatic, predictive selection of the input method does not require any manual selection of a script, language, or locality by the user. The user is not required to enter any information other than the information identifying the web page. Once a web page has been selected by the user, the input method is automatically selected based on contextual information connected with the web page.

The web page is displayed to the user. Once the input method has been predictively selected, a second input is received from the user at 104. This second input may be typing or other input at the web page. The second input is displayed at the web page according to the predictively selected input method at 105. For example, if a Japanese language input method was predictively selected, any typed input received from the user would be displayed in Japanese according to the particular input method.

If the user then requests a second web page, the contextual information for the second web page is analyzed in order to predictively select an input method based on the second web page. For example, the analysis of the contextual factors for the second web page may indicate that an English language input method should be selected. Once the appropriate input method is determined and selected, any typing received by the user would be displayed in the English language according to the selected input method.

Therefore, as a multilingual user moves between web pages, an appropriate input method for each web page is automatically, predictively selected, thereby reducing the need for the multilingual user to make a manual change to the input method. Although an input method is automatically, predictively selected, a user can still manually change the input method at any point.

Once the appropriate input method has been selected, a corresponding predictive typing algorithm may be selected an applied to the second input from the user at 106. This predictive typing algorithm reduces the amount of typing required by the user.

Various factors may be considered in analyzing the web page to predictively select an input method. More than one factor may be analyzed, and the results may be given a weight or rank in order to select the most probable input method for the web page.

One exemplary implementation may include an examination of the text encoding method that is used for the text on a particular web page in order for the web browser to make an automatic, predictive selection of the appropriate input method.

For example, the text encoding method user for the web page may be a Shift JIS text encoding. This is a Japanese national standard for encoding Japanese characters, as defined in JIS X 0208:1997, the entire contents of which are incorporated herein by reference. Once it has been determined that the web page is encoded using Shift JIS text encoding, a Japanese input method may be selected. After the input method is selected, a corresponding predictive typing program may be selected. In this case, a Japanese language predictive typing program may be applied to any text input by the user at the web page.

Although Shift JIS and a Japanese input method have been described, there are numerous types of text encoding relating to various languages such as Chinese, Russian, Korean, That, Greek, Hebrew, etc.

A second exemplary implementation may include an examination of the numerical distribution of code points in the web page. One type of text encoding used in web pages is Universal Character Encoding (UCS), such as UCS-4 that is defined in ISO/IEC 10646:2003 Universal Multiple-Octet Coded Character Set, the entire contents of which are incorporated herein by reference. As UCS is a universal type of text encoding, an input method cannot be automatically selected merely based on identifying the use of UCS. Instead, the numerical distribution of the code points (character codes) may be examined in order to identify a corresponding input method. The examination may include heuristically using the numerical ranges in which code points cluster to determine the input method.

For example, a number of characters may be included on the web page that fall within a particular range of codes. For example, using UCS-4, clusters in the range 0xAC00 through 0xD7AF (The Hangul block) would suggest that the web page includes Korean characters. Therefore, the examination of the distribution of the code points would suggest the selection of a Korean input method. Similarly, clusters in the range 0x3040 through 0x309F (the Hiragana block) correspond to Japanese characters and would imply a Japanese input method be selected.

More than one type of cluster may be identified in a particular web page. For example, a web page containing a majority of Japanese characters may also include portions in English. In order to correctly select an input method, the results from the examination may be given a weight or rank before being combined to identify the most appropriate input method. For example, the results may be weighted based on the amount of the code range used at the web page. For the above example, the majority of Japanese code ranges would outweigh the English code ranges, thereby implying that a Japanese input method should be selected rather than an English method.

In a third exemplary implementation, the actual words at a web page may be examined in order to determine an input method. Examining the words may include comparing the words to a dictionary in order to determine to which language they belong.

It is noted that a given word may appear in more than one language. This word would be representative of each of the languages in which it appears. A frequency distribution of the represented languages may be used to represent the amount of representation that each of the identified languages has on the web page. This frequency distribution may be used heuristically to select an input method. For example, the most represented language may be selected as the input method.

Additional levels of weight and rank may be applied to various words or identified languages in order to more accurately select an input method. For example, a page containing a majority of French words strongly suggests that French be selected as the input method. However, a page containing a majority of Classical Latin words and a minority of English words, would suggest English as an input method because the use of a Classical Latin input method is very rare. Classical Latin may, therefore, be given a reduced weight in order to reduce its influence on the selection of the input method. The weight and rank may be given to various types of languages or input methods according to the levels of current usage of the language or input method corresponding to the language.

In a fourth exemplary implementation, meta-information embedded in a web page may be examined for language tags. For example, a language tag may be included in an HTML fragment. The international standard defining HTML and meta data elements is described in W3C HTML 4.01 http://www.w3.org/TR/html401/, the entire contents of which are hereby incorporated by reference.

For example, an HTML fragment may include <html lang=“jp”> suggesting the selection of a Japanese input method. Input methods for other languages may be suggested by other similar language tags.

In a fifth exemplary implementation, the Uniform Resource Locator (URL) or Universal Resource Identifier (URI) of the page may be examined The Top Level Domain (TLD) of the page may be heuristically examined to determine an implied geographic location. The official list of top level domains on the Internet is given in the IANA list at http://data.iana.org/TLD/tlds-alpha-by-domain.txt, the entire contents of which are incorporated herein by reference. The input method may be selected based on a corresponding language used at the implied geographic location. If more than one language is used at the geographic location, a weight or rank may be applied to each of the languages. As with all of the exemplary implementations, this method may be used in combination with any of the other methods to select among the languages for the geographic location.

For example, the URI of the web page may be of the form http://someseryer.cn/page.html. The “cn” implies a geographical location of China for the service. Thus, a Chinese input method should be selected.

A sixth exemplary implementation may include examining the numerical distribution of code points in the URL or URI for the web page. The host part of a URI or URL may be an Internationalized Domain Name (IDN). IETF RFC 3940 Internationalizing Domain Names, the entire contents of which are incorporated herein by reference, defines the international standard defining international domain names. When the URL or URI includes an internationalized domain name, the domain name will not directly correspond to a particular geographic location. In this case, the numerical distribution of the code points in the domain name may be examined, similar to the examination described in the second exemplary implementation, in order to identify a probable language and to select an input method therefrom.

These exemplary implementations may be used in any combination and may be used in combination with an analysis of other contextual factors for the web page.

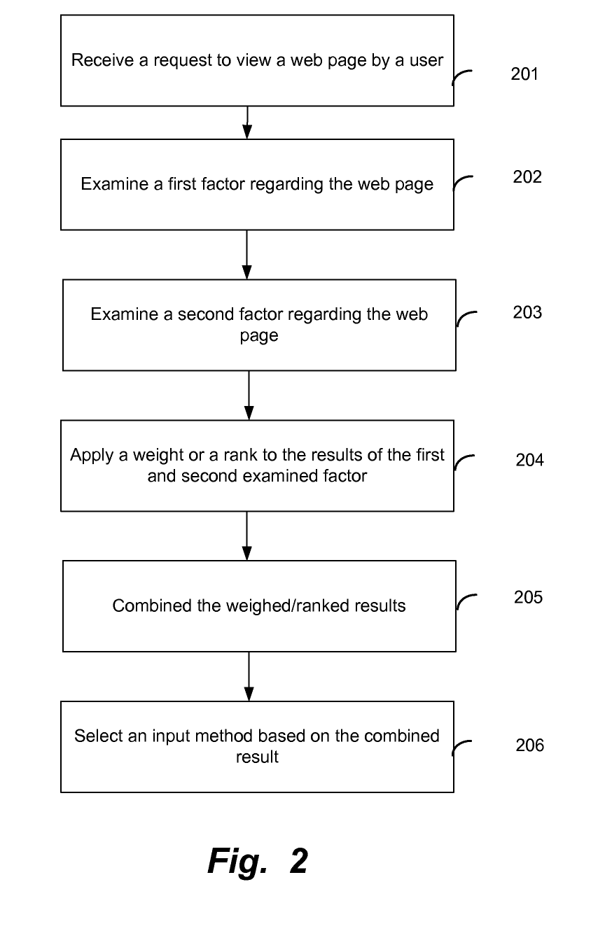

When used in combination, the results of the various examinations may be given a weight or rank in order to yield a more accurate composite selection of the appropriate input method for the web page. FIG. 2 illustrates an exemplary method that includes giving a weight or rank to the analysis of multiple contextual factors. Similar to FIG. 1, at 201, a request is received from a user to access a web page. At 202, a first factor regarding the web page is examined. At 203 a second factor regarding the web page is examined. At 204, a weight or rank is applied to the results of the examination of the first and second factor. At 205, the results are combined, after being given a weight or rank. At 206, an input method is selected based on the combined result. Once at input method is selected, an algorithm for predictive typing may also be selected based on the selected input method.

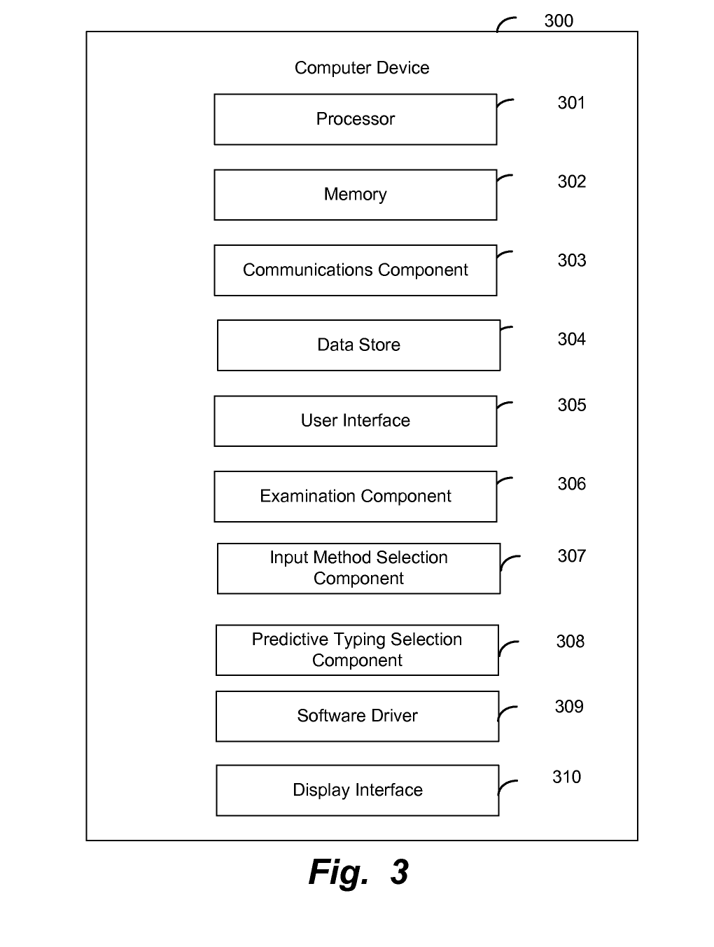

FIG. 3 illustrates aspects of a computer device 300 that automatically, predictively selects an input method from contextual information on a web page. Computer device 300 includes a processor 301 for carrying out processing functions associated with one or more of components and functions described herein. Processor 301 can include a single or multiple set of processors or multi-core processors. Moreover, processor 301 can be implemented as an integrated processing system and/or a distributed processing system.

Computer device 300 further includes a memory 302, such as for storing local versions of applications being executed by processor 301. Memory 302 can include any type of memory usable by a computer, such as random access memory (RAM), read only memory (ROM), tapes, magnetic discs, optical discs, volatile memory, non-volatile memory, and any combination thereof. The memory may store a computer program including computer software and/or data, wherein when the computer program is executed, it enables the computer device to examine at least one factor on a web page, to select an input method based on the examination, and to select a predictive typing method based on the selection of the input method. In particular, the computer software and/or data enables the processor 301, examination component 306, input method selection component 307, and predictive typing selection component 308 to perform the processes described herein.

Further, computer device 300 includes a communications component 303 that provides for establishing and maintaining communications with one or more parties utilizing hardware, software, and services as described herein. Communications component 303 may carry communications between components on computer device 300, as well as between computer device 300 and external devices, such as devices located across a communications network and/or devices serially or locally connected to computer device 300. For example, communications component 300 may include one or more buses, and may further include transmit chain components and receive chain components associated with a transmitter and receiver, respectively, operable for interfacing with external devices. For example, communication component 300 may allow forward graphics, text, and other data from the computer device for display on a display unit.

Computer device 300 may include a display interface 310 for displaying such graphics, text, and other data. For example, once an input method is selected, any user input received by the computer device 300 will be forwarded for display or displayed according to the selected input method.

Additionally, computer device 300 may further include a data store 304, which can be any suitable combination of hardware and/or software, that provides for mass storage of information, databases, and programs employed in connection with aspects described herein. For example, data store 304 may be a data repository for applications not currently being executed by processor 301.

Computer device 300 may additionally include a user interface component 305 operable to receive inputs from a user of computer device 300, and further operable to generate outputs for presentation to the user. User interface component 305 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 305 may include one or more output devices, including but not limited to a display, a speaker, a haptic feedback mechanism, a printer, any other mechanism capable of presenting an output to a user, or any combination thereof.

Computer device 300 may additionally include an examination component 306 that examines contextual factors for a web page. For example, as described above, this component may examine any of the text encoding method used on a web page, the numerical distribution of code points used on a web page, the actual words on a web page, the meta-information embedded in a web page, the URL/IRU of a web page, and the text encoding method used in the URL/URI of a web page. The examination component 306 may analyze at least one contextual factor on a web page to determine an indicated language and input method from that factor.

Computer device 300 may additionally include an input method selection component 307. This component automatically, predictively selects an input method to be applied to user input at a web page selected by the user. This component may make the selection based on the input method indicated by the examination component. Alternatively, this component may give a weight and rank to the results of multiple factors examined at the examination component and combine the results in order to select an appropriate input method.

Computer device 300 may additionally include a predictive typing selection component 308. This component selects an algorithm for predictive typing to be applied to user input at the web page selected by the user. The proper algorithm is selected based on the corresponding selected input method.

Computer device 300 may additionally include a software driver 309 for executing computer programs stored at computer device 300.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. A base station may be utilized for communicating with wireless terminal(s) and may also be referred to as an access point, a Node B, or some other terminology.

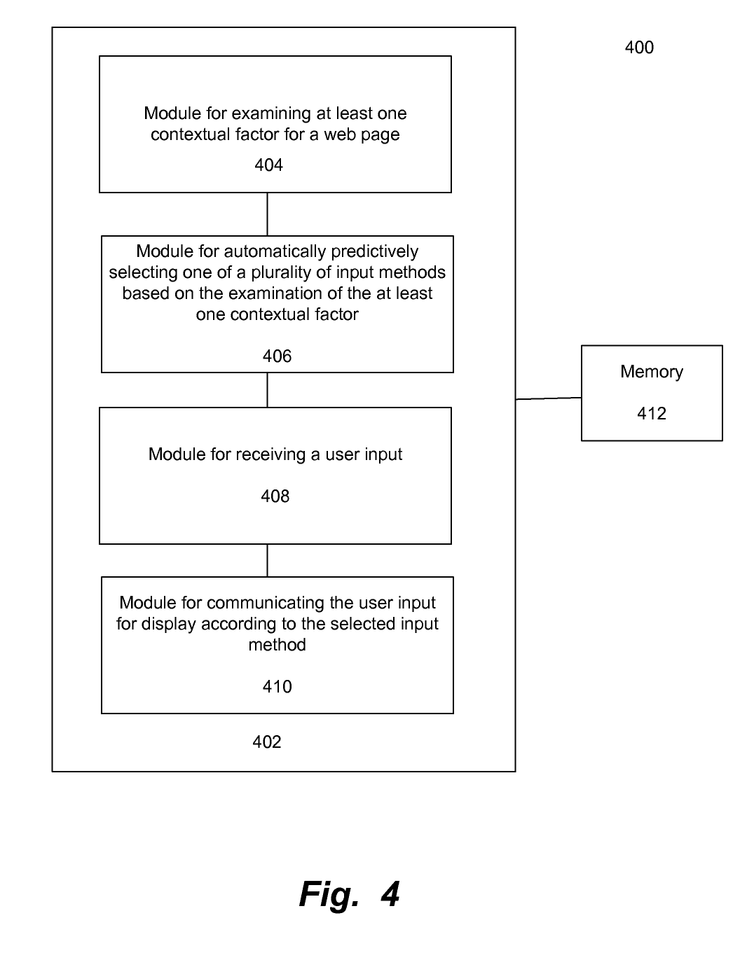

With reference to FIG. 4, illustrated is a system 400 that predictively selects an input method based on an analysis of factors associated with a website. For example, system 400 can reside at least partially within a computer device, mobile device, etc. It is to be appreciated that system 400 is represented as including functional blocks, which can be functional blocks that represent functions implemented by a processor, software, or combination thereof (e.g., firmware). System 400 includes a logical grouping 402 of electrical components that can act in conjunction. For instance, logical grouping 402 can include a module for examining at least one contextual factor for a web page 404. For example, the examination may include examining a text encoding method used for the web page, examining a numerical distribution of code points used on the web page, an examination of the actual words used on the web page, an examination of the meta-data embedded in the web page, an examination of the URI/URL of the web page, and an examination of the distribution of code points for the URL/URI of the web page.

Further, logical grouping 402 can comprise a module for automatically predictively selecting one of a plurality of input methods based on the analysis of the at least one contextual factor for the web page 406.

Furthermore, logical grouping 402 can comprise a module for receiving a user input 408 and a module for communicating the user input for display according to the selected input method 410. Thus, any user input, such as typing, will be displayed according to an automatically, predictively selected input method. Thus, an appropriate input method may be automatically selected without requiring a manual selection by a user.

Additionally, system 400 can include a memory 412 that retains instructions for executing functions associated with electrical components 404, 406, 408, and 410. While shown as being external to memory 412, it is to be understood that one or more of electrical components 404, 406, 408, and 410 can exist within memory 412.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for predictively selecting an input method at a web browser, the method comprising:
analyzing at least one contextual factor for a web page;
automatically predictively selecting one of a plurality of input methods based on the analysis of the at least one contextual factor for the web page;
receiving user input; and
displaying the user input according to the selected input method.

2. The method according to claim 1, wherein the analysis of the at least one factor includes examining a text encoding method used for the web page.

3. The method according to claim 1, wherein the web page includes universal character encoding, and wherein the analysis of the at least one factor includes examining a numerical distribution of the code points for the web page in order to determine a range in which the code points cluster.

4. The method according to claim 1, wherein the analysis of the at least one factor includes examining words on the web page in order to determine a language from the words.

5. The method according to claim 4, further comprising:
determining a frequency distribution of languages represented on the web page.

6. The method according to claim 5, further comprising:
applying a weight to the represented languages.

7. The method according to claim 1, wherein the analysis of the at least one factor includes examining meta-information embedded in the web page.

8. The method according to claim 7, wherein the examination of meta-information embedded in the web page further includes determining whether the meta-information includes a language tag.

9. The method according to claim 1, wherein the analysis of the at least one factor includes examining the Uniform Resource Locator (URL) or Universal Resource Identifier (URI) of the web page.

10. The method according to claim 9, wherein the URI or URL includes an internationalized domain name, the method further comprising:
examining the distribution of code points in the URI or URL to determine a range in which the code points cluster.

11. The method according to claim 1, wherein the analysis of the at least one factor includes at least two of examining a text encoding method used for the web page; examining a numerical distribution of the code points for the web page in order to determine a range in which the code points cluster; examining words on the web page in order to determine a language from the words; examining meta-information embedded in the web page; and examining the URI or URL of the web page.

12. The method according to claim 11, further comprising:
giving a weight to the results of the analysis of different factors.

13. The method according to claim 1, further comprising:
applying predictive typing based on the selected input method.

14. A computer program product, comprising:
a computer-readable medium comprising:
code for causing a computer to receive a first input for a web page;
code for causing the computer to analyze at least one contextual factor for the web page;
code for causing the computer to automatically predictively select one of a plurality of input methods based on the analysis of the at least one contextual factor for the web page;
code for causing the computer to receive a second user input; and
code for causing the computer to display the second user input according to the selected input method.

15. The computer program product according to claim 14, wherein the analysis of the at least one factor includes examining a text encoding method used for the web page.

16. The computer program product according to claim 14, wherein the web page includes universal character encoding, and wherein the analysis of the at least one factor includes examining a numerical distribution of the code points for the web page in order to determine a range in which the code points cluster.

17. The computer program product according to claim 14, wherein the analysis of the at least one factor includes examining words on the web page in order to determine a language from the words.

18. The computer program product according to claim 17, further comprising:
code for causing a computer to determine a frequency distribution of languages represented on the web page.

19. The computer program product according to claim 18, further comprising:
code for causing a computer to apply a weight to the represented languages.

20. The computer program product according to claim 14, wherein the analysis of the at least one factor includes examining meta-information embedded in the web page.

21. The computer program product according to claim 20, wherein the examination of meta-information embedded in the web page further includes determining whether the meta-information includes a language tag.

22. The computer program product according to claim 14, wherein the analysis of the at least one factor includes examining the Uniform Resource Locator (URL) or Universal Resource Identifier (URI) of the web page.

23. The computer program product according to claim 22, wherein the URI or URL includes an internationalized domain name, the method further comprising:
code for causing a computer to examine the distribution of code points in the URI or URL to determine a range in which the code points cluster.

24. The computer program product according to claim 14, wherein the analysis of the at least one factor includes at least two of examining a text encoding method used for the web page; examining a numerical distribution of the code points for the web page in order to determine a range in which the code points cluster; examining words on the web page in order to determine a language from the words; examining meta-information embedded in the web page; and examining the URI or URL of the web page.

25. The computer program product according to 24, further comprising:
code for causing a computer to give a weight to the results of the analysis of different factors.

26. The computer program product according to claim 14, further comprising:
code for causing a computer to apply predictive typing based on the selected input method.

27. An apparatus, comprising:
means for examining at least one contextual factor for a web page;
means for automatically predictively selecting one of a plurality of input methods based on the analysis of the at least one contextual factor for the web page;
means for receiving a user input; and
means for communicating the user input for display according to the selected input method.

28. The apparatus according to claim 27, wherein the examination of the at least one factor includes examining a text encoding method used for the web page.

29. The apparatus according to claim 27, wherein the web page includes universal character encoding, and wherein the examination of the at least one factor includes examining a numerical distribution of the code points for the web page in order to determine a range in which the code points cluster.

30. The apparatus according to claim 27, wherein the examination of the at least one factor includes examining words on the web page in order to determine a language from the words.

31. The apparatus according to claim 30, further comprising:
means for determining a frequency distribution of languages represented on the web page.

32. The apparatus according to claim 31, further comprising:
means for applying a weight to the represented languages.

33. The apparatus according to claim 27, wherein the examination of the at least one factor includes examining meta-information embedded in the web page.

34. The apparatus according to claim 33, wherein the examination of meta-information embedded in the web page further includes determining whether the meta-information includes a language tag.

35. The apparatus according to claim 27, wherein the examination of the at least one factor includes examining the Uniform Resource Locator (URL) or Universal Resource Identifier (URI) of the web page.

36. The apparatus according to claim 35, wherein the URI or URL includes an internationalized domain name, the method further comprising:
means for examining the distribution of code points in the URI or URL to determine a range in which the code points cluster.

37. The apparatus according to claim 27, wherein the examination of the at least one factor includes at least two of examining a text encoding method used for the web page; examining a numerical distribution of the code points for the web page in order to determine a range in which the code points cluster; examining words on the web page in order to determine a language from the words; examining meta-information embedded in the web page; and examining the URI or URL of the web page.

38. The apparatus according to claim 37, further comprising:
means for giving a weight to the results of the analysis of different factors.

39. The apparatus according to claim 27, further comprising:
means for applying predictive typing based on the selected input method.

40. An apparatus, comprising:
an examination component for analyzing at least one contextual factor for the web page;
an input method selection component for automatically predictively selecting one of a plurality of input methods based on the analysis of the at least one contextual factor for the web page;
a display; and
a user interface for receiving user input and presenting the user input to the display according to the selected input method.

41. The apparatus according to claim 40, wherein the examination component is configured to examine a text encoding method used for the web page.

42. The apparatus according to claim 40, wherein the web page includes universal character encoding, and wherein the examination component is configured to examine a numerical distribution of the code points for the web page in order to determine a range in which the code points cluster.

43. The apparatus according to claim 40, wherein the examination component is configured to examine words on the web page in order to determine a language from the words.

44. The apparatus according to claim 43, wherein the examination component is further configured to determine a frequency distribution of languages represented on the web page.

45. The apparatus according to claim 44, wherein the input method selection component is configured to apply a weight to the represented languages.

46. The apparatus according to claim 40, wherein the examination component is configured to examine meta-information embedded in the web page.

47. The apparatus according to claim 46, wherein the examination component is further configured to determine whether the meta-information includes a language tag.

48. The apparatus according to claim 40, wherein the examination component is configured to examine the URI or URL of the web page.

49. The apparatus according to claim 48, wherein the URI or URL includes an internationalized domain name, and the examination component is further configured to examine the distribution of code points in the URI or URL to determine a range in which the code points cluster.

50. The apparatus according to claim 40, further comprising:
a predictive typing method selection component configured to apply a predictive typing algorithm based on the selected input method.
